(19) United States
(12) Patent Application Publication
(10) Pub. No.: US 2014/0321910 A1
(43) Pub. Date: Oct. 30, 2014

(54) PINNED STRUCTURE

(71) Applicant: TAIT TOWERS MANUFACTURING, LLC, LITITZ, PA (US)

(72) Inventor: Adam DAVIS, Leola, PA (US)

(73) Assignee: TAIT TOWERS MANUFACTURING, LLC, LITITZ, PA (US)

(21) Appl. No.: 13/871,498

(22) Filed: Apr. 26, 2013

(51) Int. Cl. F16B 19/00

(52) U.S. Cl. CPC F16B 19/00
USPC 403/376; 29/464

(57) ABSTRACT

A pinned structure includes a first member having a first fastening feature extending through opposed surfaces of the first member for retainably receiving a portion of a pin therein. A second member having a surface includes a second fastening feature formed therein for receiving a portion of the pin extending from the first fastening feature for securing the first member and the second member together. The portion of the pin received by the second fastening feature is exposed relative to the surface of the second member. The pin is removable from the second fastening feature from a position along at least a surface of the first member opposite the second member and the surface of the second member exposing the pin.

### FIELD OF THE INVENTION

The present invention relates to structures, and more specifically, to pinned structures for protecting components secured thereto.

### BACKGROUND OF THE INVENTION

Structures, such as box structures for protecting components secured within the box structure, are typically assembled using mechanical fasteners, such as nuts and bolts or screws. In the case of nuts and bolts, access to opposite sides of the structural members forming a mechanical joint for the box structure must typically be provided to permit assembly. In the case of screws, the structural member receiving a threaded portion of the screw must typically also be threaded to facilitate assembly, thereby increasing the expense of the structural member For both nuts and bolts as well as screws, unless additional manufacturing processes are utilized, such as countersinks or counterbores which increase the expense of the structural members, the heads of the bolts or screws protrude outwardly from the structural member. In applications, such as portable box structures, it may be highly desirable for fastener heads used for assembling the box structures together to be substantially flush relative to the surfaces of the structural members.

Structures that may be assembled/disassembled using limited accessibility, such as only one surface, would be desirable in the art.

### SUMMARY OF THE INVENTION

In an exemplary embodiment, a pinned structure includes a first member having a first fastening feature extending through opposed surfaces of the first member for retainably receiving a portion of a pin therein. A second member having a surface includes a second fastening feature formed therein for receiving a portion of the pin extending from the first fastening feature for securing the first member and the second member together. The portion of the pin received by the second fastening feature is exposed relative to the surface of the second member. The pin is removable from the second fastening feature from a position along at least a surface of the first member opposite the second member and the surface of the second member exposing the pin.

In another exemplary embodiment, a pinned structure includes a first member having a first fastening feature extending through opposed surfaces of the first member for retainably receiving a portion of a pin therein. A second member having a surface includes a second fastening feature formed therein for receiving a portion of the pin extending from the first fastening feature for securing the first member and the second member together. The portion of the pin received by the second fastening feature is exposed relative to the surface of the second member. The pin is removable from the second fastening feature from a position along at least a surface of the first member opposite the second member and the surface of the second member exposing the pin. Upon installation of the pin in the first fastening feature and the second fastening feature, the pin is substantially flush or recessed in the first fastening feature relative to the surface of the first member opposite the second member. The pin is substantially flush or recessed in the second fastening feature relative to the surface of the second member exposing the pin.

In another exemplary embodiment, a method of assembling a pinned structure includes providing a first member having a first fastening feature extending through opposed surfaces of the first member for retainably receiving a portion of a pin therein. The method further includes providing a second member having a surface including a second fastening feature formed therein for receiving a portion of the pin extending from the first fastening feature for securing the first member and the second member together. The method further includes the portion of the pin received by the second fastening feature being exposed relative to the surface of the second member. The method further includes the pin being removable from the second fastening feature from a position along at least a surface of the first member opposite the second member and the surface of the second member exposing the pin. The method further includes aligning the first fastening feature and the second fastening feature. The method further includes installing the pin in the first fastening feature and the second fastening feature.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an upper perspective view of an exemplary embodiment of a pinned structure according to the disclosure.

FIG. 2 shows a top view taken along line 2-2 from FIG. 1 according to the disclosure.

FIG. 3 shows a side views taken along each of respective line 3-3 and line 4-4 from FIG. 1 of an exemplary engagement according to the disclosure.

FIG. 4 shows an exploded view of the pinned structure of FIG. 1, with the top and bottom members of the pinned structure removed for clarity, according to the disclosure.

FIG. 5 shows a perspective view of an exemplary structural member according to the disclosure.

FIG. 6 shows a perspective view of an exemplary structural member according to the disclosure.

FIGS. 7-10 show exemplary embodiments of a cross-section of a fastening feature taken along line 7-7 of FIG. 4 according to the disclosure.

FIGS. 11-12 show opposed perspective views of exemplary embodiment of a pinned structure according to the disclosure.

Wherever possible, the same reference numbers will be used throughout the drawings to represent the same parts.

### DETAILED DESCRIPTION OF THE INVENTION

Provided is a pinned structure and a method of assembling/disassembling a pinned structure requiring reduced access, such as from one side of the pinned structure or from interior of or from exterior of a pinned structure defining an enclosure.

FIGS. 1-3 collectively show a pinned structure 10 comprising side members 12, and top and bottom members 14 interconnected together by pins 22. Member 12 includes first fastening features 16 formed through opposed surfaces 18, 20 of member 12 and configured to retainably receive a portion of a pin 22 therein. The term retainably receive is intended to mean that at least a portion of first fastening feature maintains a frictional contact with a corresponding surface of the pin sufficient to prevent inadvertent movement of the pin relative to the first fastening feature.

The relative positional terms top, bottom and side such as associated with members 12, 14 of pinned structure 10 have been utilized to more easily facilitate understanding of the invention, but are not intended to be limiting.

Side members 12 and top and bottom members 14 are composed of suitable materials having sufficient structural strength, rigidity and resistance to environmental exposure, such as various metals, including but not limited to aluminum. Pins 22, such as roll pins or pins of solid construction are similarly composed of suitable materials having sufficient structural strength, resistance to environmental exposure, and compatibility with members 12, 14 such as various metals, including but not limited to steel.

As further shown in FIGS. 1-3, side members 12 and top and bottom members 14 include second fastening features 26 that are aligned with corresponding first fastening features 16 prior to installation or insertion of pin 22 therein. Handling features 36 can be optionally formed in side members 12, and handling features 38 can be optionally formed in top and bottom members 14 to facilitate handling of the members, providing visibility of components (not shown) located interior of pinned structure, and/or for reducing the weight of the members. As further shown in FIG. 1, pin 22 is directed through a corresponding first fastening feature 16, such as an opening or aperture formed through opposed surfaces 18, 20 of side member 12 and then into an aligned second fastening feature 26, such as a groove formed in a surface 18 of an interconnected side member 12. In one embodiment, an opening of first fastening feature 16 can include a countersink or counterbore formed therein to facilitate insertion of a pin therein or possible removal of a pin therefrom. In one embodiment, as shown in FIGS. 1-3, installed pins 22 of pinned structure 10 in the corresponding first fastening features 16 and second fastening features 26 are substantially flush or slightly recessed relative to surface 18 of side members 12 or surface 24 of top and bottom members 14.

In one embodiment, pin 22 may be directed or inserted into second fastening feature 26 of a member, and upon alignment with a first fastening feature of a corresponding member, the members can then be moved relative to one another in a direction such that a portion of pin 22 extending outwardly from second fastening feature 26 is directed into first fastening feature 16. As a result, a pinned structure can be formed.

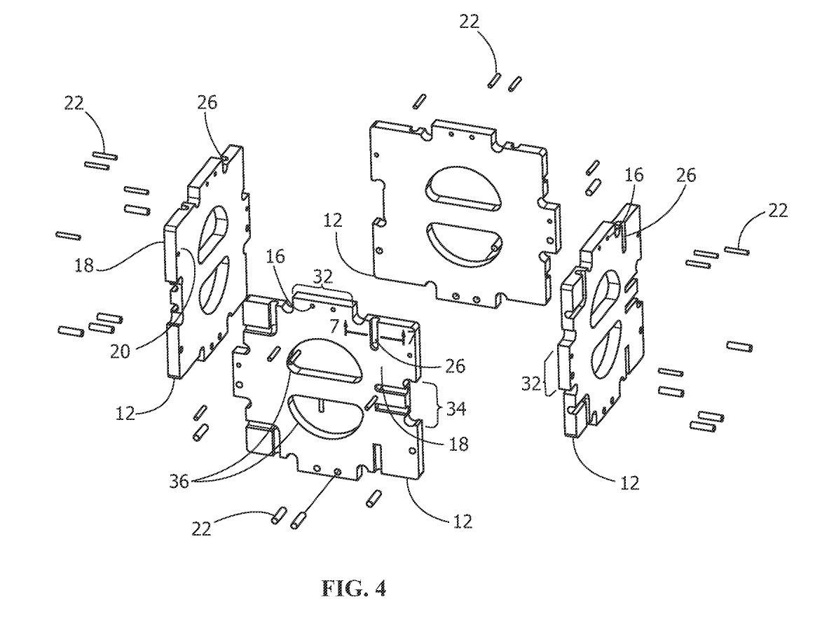

FIGS. 5-6 and 7-10 which are taken along line 7-7 from FIG. 4 show different embodiments of second fastening features 26. For example, opposed portions 28, 30 of second fastening feature 26 can be of uniform cross-section along substantially the entire length of second fastening feature 26. In one embodiment, the cross-section of second fastening feature 26 maybe non-uniform. As further shown FIG. 7, opposed portions 28, 30 of second fastening feature 26 can be substantially parallel to each other. As further shown in FIG. 8, opposed portions 28, 30 of second fastening feature 26 can be nonparallel and converge toward each other (as shown FIG. 8) or diverge away from each other. As further shown in FIGS. 9-10, segments of opposed portions 28, 30 of second fastening feature 26 can be substantially parallel to each other and then one or more of the opposed portions 28, 30 can begin to converge toward each other or diverge away from each other, so long as second fastening feature 26 can secure the corresponding segment of pin 22. In another embodiment, segments of opposed portions 28, 30 can be curved.

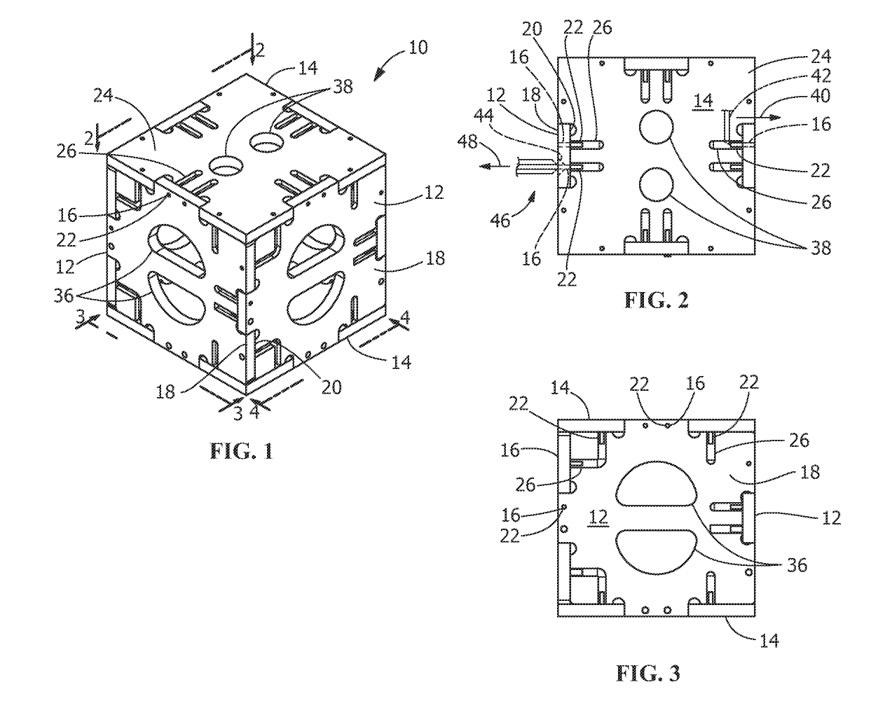

As is apparent from collectively viewing FIGS. 2-3 and 5-6, second fastening features 26 formed in surface 24 of top and bottom member 14 or formed in surface 18 of side member 12 would expose corresponding portions of pins 22 extending from an aligned first fastening feature and into second fastening feature 26. The term expose or the like refers to the portion of a pin received in a second fastening feature being in communication with and accessible from the environment surrounding or exterior of the second fastening feature. As shown in FIG. 2, pin 22 can be removed from a corresponding second fastening feature 26 formed in surface 24 of member 14 such as by insertion of a removal tool 42 positioned along surface 24 into second fastening feature 26, followed by directed movement of removal tool 42 in a direction 40 while maintaining contact with pin 22. In other words, pins 22 can be removed from a second fastening feature 26 of a member of a pinned structure having a surface (e.g., surface 18 of member 12 or surface 24 of member 14) into which second fastening feature 26 is formed, from a position along that same surface. Stated another way, removal of pins 22 do not require access to surfaces in addition to the surface into which the second fastening feature 26 is formed.

As further shown in FIG. 2, optionally an additional feature, such as a counterbore or countersink 44 formed in first fastening feature 16 permits removal of pin 22 by a removal tool 46 by directed movement of removal tool 42 in a direction 48 relative to the first fastening feature 16 while maintaining gripping contact of the portion of the pin 22 extending into countersink 44. In other words, pins 22 can be removed from corresponding first fastening features 16 of a member of a pinned structure having a surface (e.g., surface 18 of member 12 or surface 24 of member 14) into which a first fastening feature 16 is formed, from a position along that same surface. For an assembled pin structure, the surface corresponding to a first surface feature 16 of a member for removal of a pin 22 by removal tool 46 would be opposite to the surface that is in abutting contact with an interconnecting member (see FIG. 2; surface 20 of member 12 abutting member 14).

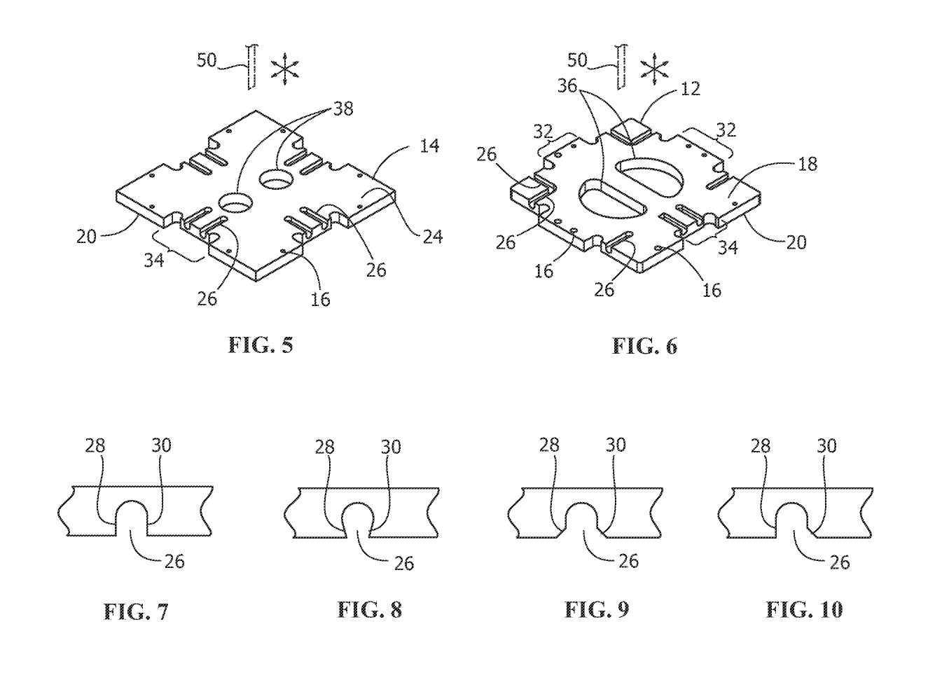

As a result of the arrangement of features in the disclosure, as shown in FIGS. 5 and 6, a feature forming device 50, such as a cutting/forming tool positioned along a surface of a piece of material stock, such as sheet stock, can cut out and form all features of both top and bottom member 14 and side member 12. For clarification, the term “positioned along a surface” is intended to only require movement (access) of a forming tool or pin removal tool to movement continuously facing the surface of member. In one embodiment, the forming tool or pin removal tool is restricted to movement facing the surface of member and along the member sufficient to cut along the perimeter of the member (to cut out the part from a piece of material stock).

To further assist with alignment of members 12, 14 prior to insertion of pins 22, corresponding guide features 32, 34 formed in the members are brought together, such as shown in exploded view FIG. 4.

It is to be understood that the first and second fastening features of the present disclosure are not limited to structural members that are planar or are interconnected mutually perpendicular to each other. In one embodiment, ends of interconnected members may form beveled joints having angles relative to each other different than 90 degrees. In one embodiment, one or more of interconnected members may include curved surfaces. In one embodiment, a portion of one or more of the connecting pins may extend outwardly from the first and/or second fastening features past the corresponding surface of the member. In other words, one or more portions of the pin may not be substantially flush or recessed relative to the corresponding surface of the member, such as extending outwardly from the surface of the member.

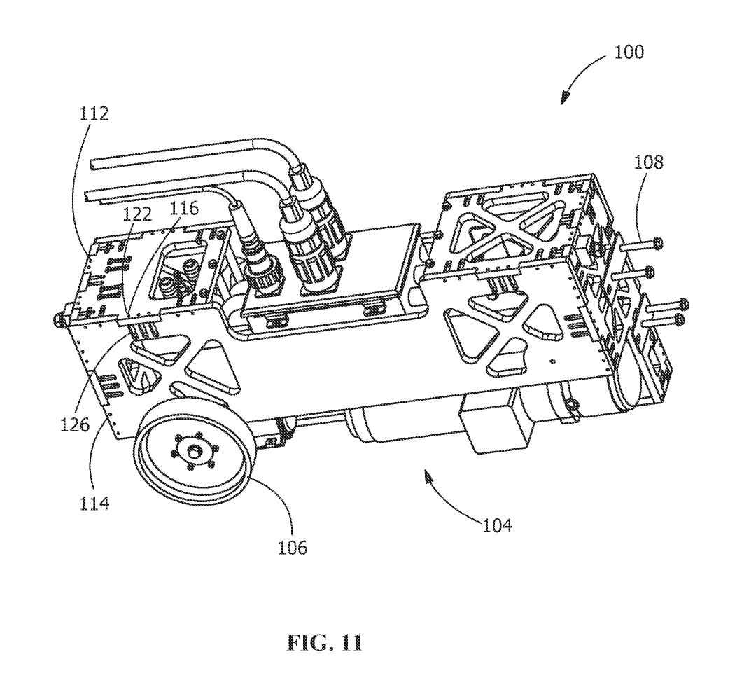

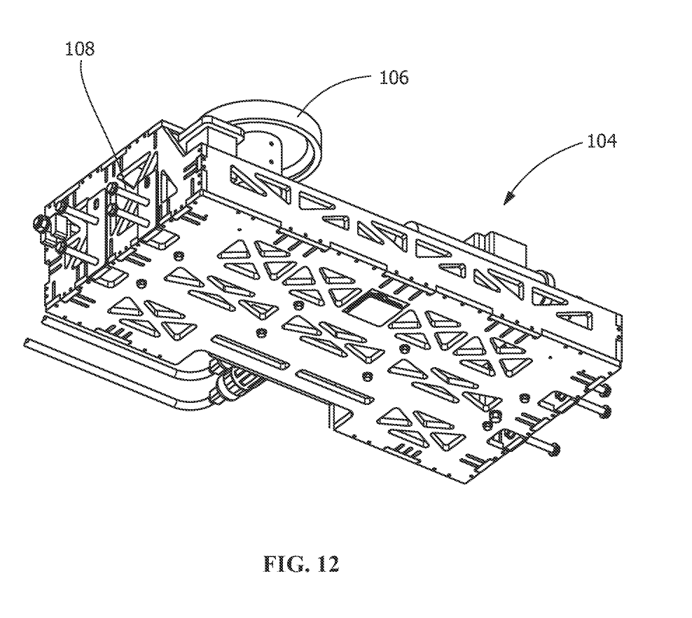

FIGS. 11 and 12 show a pinned structure 100 including a motor 104 providing rotational motion to a wheel or gear 106, such as for moving the pinned structure 100 along a track (not shown). While pinned structure 100 includes interconnected members 112, 114 utilizing pins 122 that are inserted in corresponding first fastening features 116 and second fastening features 126, motor 104 and other components may be utilized to receive other types of fasteners such as bolts 108 or other suitable fasteners. In one embodiment, a pinned structure can include an internally pinned inner wall or compartment, if desired.

It is to be understood that cross-sectional shapes of first fastening features, second fastening features and pins may be different than those shown in the exemplary embodiment herein, so long as the pins hold corresponding first fastening features and second fastening features of the structural members together, and additionally permit removal of pins from a position facing a surface in which a groove of a second fastening feature is formed. In one embodiment, the magnitude of cross-section of at least one of the first fastening features, second fastening features and pins may be different from at least one first fastening feature, second fastening feature and pin. In one embodiment, removal can be achieved from a position facing a surface of a member, such as side member 12 that is opposite another member, such as an interconnecting side member 12, or such as an interconnecting top member 14 or bottom member 14.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A pinned structure comprising:
a first member having a first fastening feature extending through opposed surfaces of the first member for retainably receiving a portion of a pin therein; and
a second member having a surface including a second fastening feature formed therein for receiving a portion of the pin extending from the first fastening feature for securing the first member and the second member together, the portion of the pin received by the second fastening feature being exposed relative to the surface of the second member;
wherein the pin is removable from the second fastening feature from a position along at least a surface of the first member opposite the second member and the surface of the second member exposing the pin.

2. The pinned structure of claim 1, wherein the first fastening feature comprises an aperture.

3. The pinned structure of claim 1, wherein the first fastening feature comprises a pin guide feature.

4. The pinned structure of claim 1, wherein the second fastening feature comprises a groove.

5. The pinned structure of claim 4, wherein the groove has a substantially uniform cross section.

6. The pinned structure of claim 4, wherein opposed portions of the groove are substantially parallel.

7. The pinned structure of claim 4, wherein opposed portions of the groove are nonparallel.

8. The pinned structure of claim 4, wherein a segment of opposed portions of the groove diverge.

9. The pinned structure of claim 4, wherein a segment of opposed portions of the groove converge.

10. The pinned structure of claim 1, wherein upon installation of the pin in the first fastening feature and the second fastening feature, the pin is substantially flush or recessed in the first fastening feature relative to the surface of the first member opposite the second member.

11. The pinned structure of claim 10, wherein the pin is substantially flush or recessed in the second fastening feature relative to the surface of the second member exposing the pin.

12. The pinned structure of claim 1, wherein the first member and the second member have corresponding guide features for aligning the first fastening feature and the second fastening feature.

13. The pinned structure of claim 1, wherein all features are formed in each of the first member in the second member by feature forming devices continuously facing a same surface of each of the first member and the second member.

14. A pinned structure comprising:
a first member having a first fastening feature extending through opposed surfaces of the first member for retainably receiving a portion of a pin therein; and
a second member having a surface including a second fastening feature formed therein for receiving a portion of the pin extending from the first fastening feature for securing the first member and the second member together, the portion of the pin received by the second fastening feature being exposed relative to the surface of the second member;
wherein the pin is removable from the second fastening feature from a position along at least a surface of the first member opposite the second member and the surface of the second member exposing the pin;
wherein upon installation of the pin in the first fastening feature and the second fastening feature, the pin is substantially flush or recessed in the first fastening feature relative to the surface of the first member opposite the second member, and the pin is substantially flush or recessed in the second fastening feature relative to the surface of the second member exposing the pin.

15. The pinned structure of claim 14, wherein the first fastening feature comprises an aperture.

16. The pinned structure of claim 14, wherein the first fastening feature comprises a pin guide feature.

17. The pinned structure of claim 14, wherein the second fastening feature comprises a groove.

18. The pinned structure of claim 17, wherein the groove has a substantially uniform cross section.

19. The pinned structure of claim 17, wherein opposed portions of the groove are substantially parallel.

20. A method of assembling a pinned structure comprising:
providing a first member having a first fastening feature extending through opposed surfaces of the first member for retainably receiving a portion of a pin therein;
providing a second member having a surface including a second fastening feature formed therein for receiving a portion of the pin extending from the first fastening feature for securing the first member and the second member together, the portion of the pin received by the second fastening feature being exposed relative to the surface of the second member, the pin being removable from the second fastening feature from a position along at least a surface of the first member opposite the second member and the surface of the second member exposing the pin.
aligning the first fastening feature and the second fastening feature; and
installing the pin in the first fastening feature and the second fastening feature.
